(19) United States
(12) Patent Application Publication
(10) Pub. No.: US 2005/0157999 A1
(43) Pub. Date: Jul. 21, 2005

(54) Graded index polymer optical fiber and a method of making the same

(76) Inventors: Zhen Zhen, Beijing (CN); Xinhou Liu, Beijing (CN)

Correspondence Address: PERKINS COIE LLP, POST OFFICE BOX 1208, SEATTLE, WA, 98111-1208, US

(21) Appl. No.: 10/883,634

(22) Filed: Jun. 30, 2004

Related U.S. Application Data
(63) Continuation of application No. PCT/US02/41595, filed on Dec. 27, 2002.

(51) Int. Cl. G02B 6/22

(52) U.S. Cl. 385/127; 385/124; 385/145

(57) ABSTRACT

One embodiment of the invention is a multi layer GI POF where each layer comprises essentially one polymer and one or more dopants. Each layer may comprise the same or different polymers although it is preferred that each layer comprise the same homopolymer. Useful dopants include cyclic or acyclic organic compounds of less than about 20 carbons, alkyl metal oxides or rare earth alkyl oxides. Another embodiment of the invention is a method of making the GI POF according to the invention.

### CROSS-REFERENCE TO RELATED APPLICATION

The present application is a continuation of PCT International Application No. PCT/US02/41595, filed Dec. 27, 2002, and published in English under PCT Article 21(2) on Jul. 17, 2003 as publication No. WO 03/057473 A1, which claims priority to U.S. patent application Ser. No. 10/038,964, filed Dec. 31, 2001 and U.S. patent application Ser. No. 10/039,046, filed Dec. 31, 2001, all of which are incorporated herein in their entirety by reference, including drawings.

### FIELD OF THE INVENTION

The instant invention generally relates to polymer based optical fiber which is suitable for use in telecommunications.

### BACKGROUND OF THE INVENTION

The present invention relates to an improved graded index (GI) polymer optical fiber (POF) and the methods of making the improved GI POF.

Typical, 10/100 Ethernet line area networks (“LANs”) are connected using twisted pair Category (“Cat”) 3/5 cabling. Although Cat 3/5 cabling is effective for LAN connections it is far from a perfect solution. For Ethernet 10/100 speeds, Cat 3/5 cabling is sufficient. In order to upgrade to 1 Gigabit Ethernet, however, network managers will need to replace Cat 5 cabling with optical fiber. In addition, all twisted pair cabling is susceptible to RF interference, which limits its applicability in noisy RF environments. One transmission layer solution to the bandwidth and RF limitations of twisted pair cable is to replace twisted pair cable with either glass optical fiber (GOF) or plastic optical fiber (POF).

GOF, although offering far superior optical transmission properties than POF, is not commercially practicable for most LANs (<150 m) with a large numbers of connections because of the high connectivity costs associated with terminating glass optical fiber. Cutting and terminating GOF is expensive for a number or reasons. Typical GOF, such as 50/125 multimode fiber or 10/125 single mode fiber, has a very small diameter and it is brittle. The relatively small diameter of GOF, requires that the angle of the incident light be tightly controlled. In order to tightly control the angle of the incident light into a fiber, the fiber must be carefully cut and inserted into a precision connector. Accordingly, special tools, trained technicians and expensive, precision connectors are required to terminate GOF. In the desk-top environment of a line area network where connections need to be taken down and put-up rapidly, this makes the connectivity costs of GOF are prohibitive.

POF offers many of the benefits of GOF, namely supporting much higher data rates than twisted pair copper cable and immunity to RF interference, but without the high connectivity costs associated with GOF. POF typically has a much larger diameter—approximately 1 mm—relative to the diameter of GOF. This larger diameter permits lower connector tolerances without a loss of optical coupling efficiency and does not require the expensive polishing step required for terminating GOF. POF can be terminated by an untrained worker using a hot plate. Additionally, POF links may employ low cost 500-800 nm LEDs.

POF may be characterized by its radial index of refraction. In step index (SI) POF, the radial index of refraction is essentially a step function, in graded index (GI) POF, the radial index of refraction is peaked at the center of the optical fiber and falls off non-linearly as a function of increasing radius. SI POF is inexpensive relative to GI POF, but because of its inherent modal dispersion properties, it is generally ineffective for higher speed data connections. For high speed applications, GI POF is preferred.

Various graded index (GI) POFs and various methods of making GI POFs are known. One GI POF comprises multiple annular layers of copolymers. See U.S. Pat. No. 6,307,992B (the '992 Patent). For the purposes of the instant invention a layer of a GI POF refers to either the core or the annular layers surrounding the core in a GI POF. Each polymer of the copolymer pair is characterized by a different index of refraction. Accordingly, by varying the copolymer composition of each layer the index of refraction may be graded as a function of the fiber radius. The GI POF according the '992 Patent contains a number of important limitations. First, because the polymers comprising each layer are large molecules, the polymers cannot readily diffuse between layers. Thusly, as indicated by FIG. 1 in the '992 Patent, the index of refraction of the POF as a whole, is not a smooth radial function, but a series of step functions for each layer. Secondly, in order to avoid inter-layer and intra-layer phase separation, the composition of each layer is limited and thus the range of refractive indices is limited. In general, the more chemically similar are the polymers comprising a copolymer, the more stable that copolymer is to phase separation. However, the more chemically similar are two polymers, the more similar are their respective indices of refraction. Accordingly, the GI POF of the '992 Patent has a significant deficiency; increasing the thermodynamic stability of the POF limits the range of the index of refraction.

Two closely related GI POFs are comprised of multiple annular layers in which each layer comprises multiple polymers. Japanese Patent Laid Open No 130904/'86 and Japanese Patent Laid Open 265208/'89. The GI POF according to these inventions contain the same deficiencies as the '992 application for the same reasons. The polymer mixtures comprising each layer tend to produce heterogeneous structures due to microscopic or macroscopic phase separation and hence have large scattering losses.

In view of the inherent deficiencies of multiple polymer based GI POF, one object of the present invention is a GI POF which is formed from multiple, annular layers of substantially of one polymer. Another object of the present invention is an improved GI POF where the radial index of refraction may be varied without compromising the thermodynamic stability of the POF. Another object of the present invention is an improved GI POF where the index of refraction more closely approximates a smooth, continuous function of the POF radius. A still further object of the present invention is a POF with increased maximum bandwidth. A still further object of the invention is a method of making an improved GI POF with the foregoing improvements over the art.

### SUMMARY OF THE INVENTION

One embodiment of the invention is a multi layer GI POF where each layer comprises essentially one polymer and one or more dopants. Each layer may comprise the same or different polymers although it is preferred that each layer comprise the same homopolymer. Suitable polymer may be formed from polymerization of monomers or prepolymers of methacrylate, styrene, or their halogenated derivatives. Useful dopants include cyclic or acyclic organic compounds of less than about 20 carbons, alkyl metal oxides or rare earth alkyl oxides.

Another embodiment of the invention is a method of making the GI POF according to the invention comprising the steps of preparing at least three spinning materials having different refractive indices, each of the spinning materials being made of at least one polymer and at least one dopant, feeding the spinning materials to a concentric nozzle so that the refractive index decreases toward the outer periphery, and thereby extruding the spinning materials through the nozzle and allowing the dopant or dopants to diffuse between adjacent layers of the fiber within the nozzle, after extrusion from the nozzle or within the nozzle and after extrusion from the nozzle.

### BRIEF DESCRIPTION OF THE FIGURES

FIGS. 1a-b illustrate a GI POF according to the invention.

FIG. 2 shows a representative radial index of refraction of the GI POF fabricated according to Example 1.

FIG. 3 shows a representative index of refraction of the GI POF fabricated according to Example 2.

FIG. 4 shows a representative index of refraction of the GI POF fabricated according to Example 3.

### DETAILED DESCRIPTION OF THE INVENTION

The GI POF According To The Invention

FIGS. 1a-b illustrate a GI POF according to the invention. FIG. 1a is a cross-sectional view and FIG. 1b is a longitudinal section. The GI POF according to the invention comprises multiple layers and each layer may be characterized by its polymer/dopant concentrations and by its radial index of refraction. Although FIG. 1 only shows 3 layers, there in no inherent limitation on the number of layers, the fiber diameter, or the fiber length of the GI POF according to the invention. In general as the number of layers in a GI POF is increased, the bandwidth and loss characteristics of the GI POF may be improved.

GI-POF according to the invention may range from about 0.5 mm to about 2 mm, with about 1 mm preferable. A given optical fiber may comprise from 3 and 30 layers. For most optical transmission applications, including 10/100 Ethernet cabling, 5-10 layers are sufficient. A preferred embodiment of the invention comprises five layers, the diameter of the central layer is approximately 0.25 mm, the thickness of next three layers (the second, third, and fourth layers) is approximately 0.075 mm and the outer layer (the fifth layer) is approximately 0.15 mm.

The GI POF may have numerical apertures of approximately 0.1 to approximately 0.5. Lower numerical apertures cause bending losses and coupling losses. Higher numerical apertures limit the maximum bandwidth. Accordingly, preferred numerical apertures are between approximately 0.2 and approximately 0.3

A protective layer if utilized, should be formed from a material having a lower index of refraction than the outer layer in order to prevent scattering out of the fiber. Additionally, a protective layer should be resistant to chemical and thermal degradation and also possess a low frictional coefficient. Suitable layers for forming a protective layer include polymers and copolymers of tetrafluoroethylene such as Teflon PFA, Teflon AF, and Teflon FEP. A preferred protective layer comprises a copolymer of approximately 65-95% by weight vinylidene fluouride and approximately 5-35% by weight of Teflon AF.

Each layer in the GI POF according to the invention is preferably formed from principally one polymer and one or more dopants. For the purposes of this invention, a polymer is any compound formed by polymerizing constituent monomers or prepolymers. By choosing the same homopolymer in each layer and varying the refractive index modifying dopant concentration in each layer, intra-layer and inter-layer phase separation may be avoided. The advantages of the GI POF according to the invention inhere from the use of a dopant to adjust the refractive index of essentially a homopolymer layer, rather than a using mixture of polymers to adjust the refractive index of each layer. In the GI POF according to the invention, each layer is chemically similar at much smaller length scale than is the current GI POFs because it is essentially a homopolymer composition. To make an analogy to solvation in a liquid, each layer of the GI POF according to the invention is like a solid state version of a solvated solute. The polymers form a “solvation shell” around uniformly distributed dopant molecules. Accordingly, phase separation effects and interfacial scattering effects are mitigated. Additionally, because the dopant is a small molecule relative to the polymer chains, and because each layer is comprised of essentially the same polymer, the dopant can readily diffuse within a layer and between layers, thus permitting matching of the index of the refraction between the POF layers.

One skilled in the art will recognize, that the chemical properties of a copolymer system will approach a homopolymer system as the concentration of one polymer approaches unity or if the copolymers have nearly identical chemical properties. It thus follows that GI POF according to the invention may also be formed: 1) from a copolymer system if one polymer is in great excess (>80% by molar stoichiometry) or 2) if each polymer has very similar chemical properties, from a mixture of polymers. For the purposes of GI POF, the relevant chemical properties are the bulk density of each copolymer, the speed of polymerization of each copolymer and the bulk index of refraction of each copolymer. In general the bulk density of each copolymer, the speed of polymerization of each copolymer and index of refraction of each copolymer should not vary by more than 3% and even more preferably, should not vary by more than 1.5%. It thus also follows, that GI POF according to the invention may be formed from multiple copolymer layers each containing one or more dopants subject to the above limitations.

Polymers for constructing POF are well known in the art. Many of the polymer systems which may be used for constructing POFs employ polymerization reactions of methacrylates, styrenes or their respective derivatives. Since there are cost structure advantages for employing 500-800 nm LEDs, it is important to minimize optical absorption between 500-800 nm. A significant source of optical absorption in these frequencies is caused by vibrations of the OH, CH, and NH bonds, all of which are common to methacrylate and styrene based polymers. In order to mitigate vibrational absorption by hydrogen terminated bonds, hydrogen atoms may be replaced by heavier substituents, such as halogen atoms. In addition, to decreasing absorption, halogen substitution also permits adjusting the bulk index of refraction of the halogenated polymers relative to the index of refraction of the unsubstituted polymers. For example, substitution of hydrogen atoms in methacrylate and styrene polymers with fluorine atoms tends to decrease the index of refraction. By contrast, substitution of chlorine atoms tends to increase the index of refraction in the same polymer systems.

Accordingly, the layers of the GI-POF according to the invention may be comprised of polymers formed from the polymerization of monomers or prepolymers selected from the group consisting of: methyl methacrylate (n=1.4908 ); glycidyl methacrylate (n=1.5174); benzyl methacrylate (n=1.5680), phenyl methacrylate (n=1.5706), vinyl benzoate (n=1.5775), styrene (n=1.5920), p-fluorostyrene (n=1.566), 2-chloroethyl methacrylate (n=1.5170), isobornyl methacrylate (n=1.505), adamantyl methacrylate (n=1.535), tricylodecyl methacrylate (n=1.523), 1-methylcyclohexyl methacrylate (n=1.5111), 2-chlorocyclohexyl methacrylate (n=1.5179), glycidyl methacrylate (n=1.517) and methyl α-chloroacrylate (n=1.5172); 2,2,2-trifluoroethyl methacrylate (n=1.415), 2,2,3,3-tetrafluoropropyl methacrylate (n=1.422), 2,2,3,3,3-pentafluoropropyl methacrylate (n=1.392), 2,2,2,-trifluoro-1-trifluoromethylethyl methacrylate (n=1.380), 1,3-dichloropropyl methacrylate (n=1.5270), 2-chloro-1-chloromethylethyl methacrylate (n=1.5270), 1-phenylethyl methacrylate (n=1.5490), 2-phenylethyl methacrylate (n=1.5592), diphenylmethyl methacrylate (n=1.5933), 1,2-diphenylethyl methacrylate (n=1.5816), 1-bromoethyl methacrylate (n=1.5426), benzyl acrylate (n=1.5584), α, α-dimethylbenzyl methacrylate (n=1.5820), bornyl methacrylate (n=1.5059), cyclohexyl methacrylate (n=1.5066), tetrahydrofurfyl methacrylate (n=1.5096), allyl methacrylate (n=1.5196), tetrahydrofurfuryl methacrylate (n=1.5096), vinyl chloroacetate (n=1.5120), 2,2,3,4,4,4-hexafluorobutyl methacrylate (n=1.407), 2,2,3,3,4,4,5,5-octafluoropentyl methacrylate (n=1.393), 2,2,2-trifluoroethyl α-fluoroacrylate (n=1.386), 2,2,3,3-tetrafluoropropyl α-fluoroacrylate (n=1.397), 2,2,3,3,3-pentafluoropropyl α-fluoroacrylate (n=1.366), 2,2,3,3,4,4,5,5-octafluoropentyl α-fluoroacrylate (n=1.376), o- or p-difluorostyrene (n=1.4750), vinyl acetate (n=1.4665), tert-butyl methacrylate (n=1.4638), isopropyl methacrylate (n=1.4728), hexadecyl methacrylate (n=1.4750), isobutyl methacrylate (n=1.4770), ac-trifluoromethacrylates, β-fluoroacrylates, β,β-difluoroacrylates, α-trifluoromethacrylates, β,β-bis(trifluoromethyl) acrylates and α-chloroacrylates.

In the present invention a dopant refers to any compound which is mixed with a polymer to adjust the index of refraction of the resulting polymer/dopant combination above or below the index of refraction of the pure polymer. In general dopants should be non-polymerizing, low molecular weight compounds which will easily diffuse through a polymer matrix and be thermally stable at polymer curing temperatures. By choosing dopants which may readily diffuse through a polymer matrix, the refractive index of a given layer and the refractive index across two layers may be closely matched. The refractive index of a particular polymer/dopant system is a function of the concentration and particular polymer(s) and dopant(s) employed. The refractive index of the pure polymer may in general be increased by adding dopants which are larger than the organic groups comprising the polymer framework. Conversely, the refractive index of the pure polymer may be in general be decreased by adding dopants which are smaller than the organic groups comprising the polymer framework. Additionally, dopants which have an index of refraction varying as a function of applied electric, magnetic, or electromagnetic fields may be used to create a GI POF where the index of refraction may be adjusted as a function of an applied field or an optical pumping source.

Suitable dopants include linear or branched, saturated or unsaturated, cyclic or acyclic organic compounds with less than about 20 carbons. Dopants are only limited by the requirements that they must modify the index of refraction of a pure polymer when mixed with the polymer and they must be sufficiently small to effectively diffuse throughout the polymer matrix during the GI POF formation process. Some dopants which may be employed to form the GI POF according to the invention include diphenyl phthalate, phenyl benzoate, benzylbutylphthalate, benzyl benzoate, diphenyl sulfide, 3-phenyl-1-propanol, benzyl methacrylate, halogenated cyclic compounds, such as bromobenzene, 1,4 dibromobenzene, bromonapthalene, 1, 2, 4-trichloro benzene, o-dichlorobenzene, m-dichlorobenzene, 1,2-dibromethane, phthalic acids, benzoic acids, naphthalenes, cyclic ethers such as dibenzyl ether, phenoxy toluene, diphenyl ether, bicyclic compounds such as biphenyl, diphenyl sulfide, diphenyl methane 1-methoxyphenyl-1-phenylethane, alkyl metal oxides and rare earth alkyl oxides.

Dopant concentrations in each layer may range from about 0% to about 30% by weight of each layer. At the high end of the dopant concentration range, consideration of the particular dopant and polymers may be required in order to mitigate phase separation, however, because of the relatively small size of the dopant molecules relative to the polymer chains, the phase separations concerns would be less than in a copolymer systems with comparable copolymer concentrations.

Methods of Fabricating the GI POF According To The Invention

Another embodiment of the invention is a method for fabricating the GI POF according to the invention. In a first step, for each layer of the GI POF according to the invention, essentially one kind of monomer and one or more dopants are mixed to form a polymer/dopant material suitable for spinning. In a second step, the spinning materials produced in step one are extruded to form a multi-layered GI POF. In a third step, the fiber of step two is drawn to produce a GI POF of a given diameter.

In order to produce the spinning material for each layer of the GI POF according to the invention, essentially one preferred monomer, one or more preferred dopants, a polymer initiator and a suitable monomer specific chain transfer agent are mixed and allowed to form the polymer dopant spinning material comprising each layer. While each layer preferably comprises essentially a homopolymer, as was discussed in the foregoing, each layer may also comprise a copolymer. Thusly, one or more monomers may also mixed with one or more dopants to form a copolymer/dopant spinning material.

The radial index of refraction of each layer, and accordingly, the radial index of refraction of the GI POF as a whole, is controlled by the particular polymers, dopants and their respective concentrations used to form each layer. In general, the index of refraction of each layer is controlled by the bulk index of refraction of the pure polymer. The bulk index is then adjusted up or down in proportion to the concentration of the dopants in each layer.

The polymerization step may be achieved in a batch or continuous process. The temperature, heating time and heating profile required to polymerize each polymer/dopant combination is specific to each polymer/dopant combination and is either within knowledge of one ordinarily skilled in art or may be determined by one ordinarily skilled in the art without undue experimentation.

In step two, each spinning material is extruded through a concentric nozzle to produce a multi layer GI POF fiber. The extrusion process occurs preferably between 150° C. to 300° C., but more preferably between 210° C. and 240° C., in order to maintain a sufficient viscosity during the extrusion process and so that the dopants may readily diffuse throughout each layer and between adjoining layers.

To match the index of refraction at the interface of any two adjacent layers, adjacent layers are brought into contact with each other during the extrusion process for a sufficient interval of time to allow the dopants to diffuse between adjacent layers. This may occur in the concentric circular nozzle of the extruder or after the nozzle if there is a diffusion tube. For the purposes of this invention, a diffusion tube, is a post extrusion cylindrical chamber that is maintained at a temperature such that when the extruded multi layer fiber passes through the tube, the dopants may diffuse between adjacent layers.

In the third step, the extruded multi-layer fiber is then drawn from the exit die of the concentric nozzle and/or diffusion tube to a desired diameter using drawing processes well known in the art. The present invention is further illustrated by the following examples.

### EXAMPLE 1

Example 1 discloses a 5 layer GI POF in which each layer comprises a poly methyl methacrylate (“PMMA”) homopolymer doped with bromobenzene and a method of making the same. In the step one, five spinning materials are produced having varying refractive indices. To polymerize each spinning material, bromobenzene is mixed with methyl methacrylate (hereinafter “MMA”), a polymerization initiator, benzoyl peroxide (hereinafter “BPO”), and a chain transfer agent, normal butyl mercaptan (hereinafter “nBM”) according to the following:

| | |
|---|---|
| Spinning Material #1 | |
| Bromobenzene- | 20% by weight |
| BPO- | 0.5% by weight |
| nBM- | 0.2% by weight |
| MMA- | remainder |
| Spinning Material #2 | |
| Bromobenzene- | 15% by weight |
| BPO- | 0.5% by weight |
| nBM- | 0.2% by weight |
| MMA- | remainder |
| Spinning Material #3 | |
| Bromobenzene- | 10% by weight |
| BPO | 0.5% by weight |
| nBM- | 0.2% by weight |
| MMA- | remainder |
| Spinning Material #4 | |
| Bromobenzene- | 5% by weight |
| BPO- | 0.5% by weight |
| nBM- | 0.2% by weight |
| MMA- | remainder |
| Spinning Material #5 | |
| Bromobenzene- | 0.0% by weight |
| BPO- | 0.5% by weight |
| nBM- | 0.2% by weight |
| MMA- | remainder |

The spinning materials are polymerized at 75° C. for approximately 24 hours by methods commonly known in the art.

In step two, each spinning material is extruded at 210° C. through a concentric circular nozzle. Spinning material No. 1 forms the fiber core and spinning material Nos. 2-5 form each consecutive layer with spinning material No. 5 forming the outermost layer. The multi-layered fiber produced by the extrusion process is 10 millimeters in diameter and 5 to 1000 millimeters in length.

In order to match the index of refraction at the interface between adjacent layers, adjacent layers are pair-wise brought into contact with each other in the extrusion nozzle and in a subsequent diffusion tube (assuming a 500 mm diffusion tube which is maintained in thermal equilibrium at 210° C. with the extrusion nozzle) for 50 seconds.

In step three, the multi-layer fiber is then drawn from the die head at one meter per second at the temperature of the die head to the desired diameter of 1 millimeter by methods commonly known in the art.

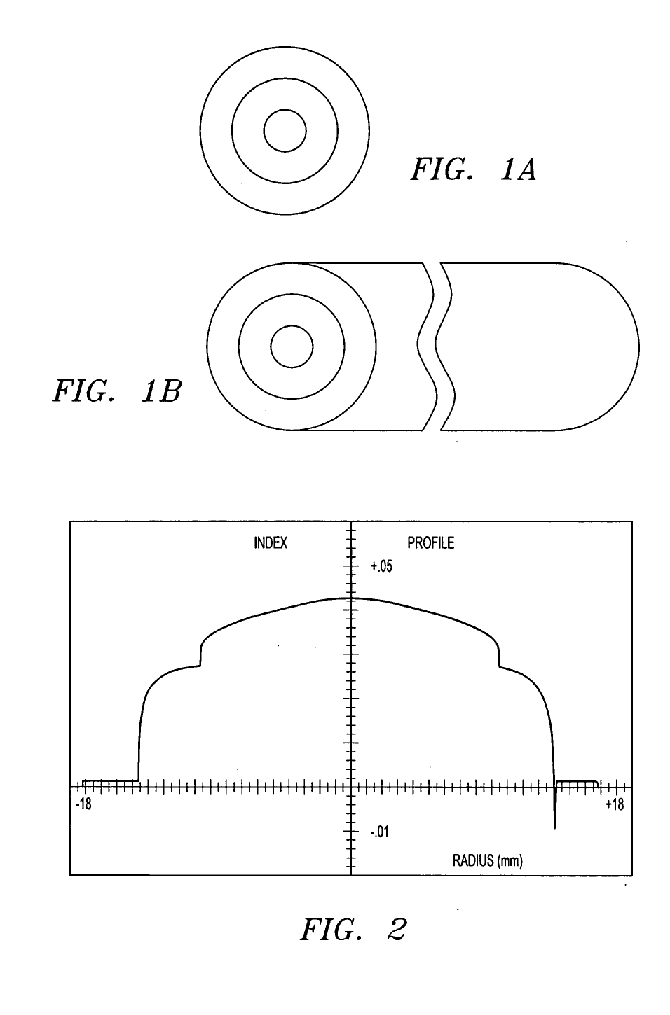

FIG. 2 shows a representative radial index of refraction of the GI POF fabricated according to Example 1.

### EXAMPLE 2

Example 2 discloses another 5 layer GI POF in which each layer comprises a PMMA homopolymer doped with bromobenzene and a method of making the same. The same method described in Example 1 is used to produce the fiber of Example 1 except as noted below. The spinning materials for Example 2 are as follows:

| | |
|---|---|
| Spinning Material #1 | |
| Bromobenzene- | 17% by weight |
| BPO- | 0.5% by weight |
| nBM- | 0.2% by weight |
| MMA- | remainder |
| Spinning Material #2 | |
| Bromobenzene- | 13% by weight |
| BPO- | 0.5% by weight |
| nBM- | 0.2% by weight |
| MMA- | remainder |
| Spinning Material #3 | |
| Bromobenzene- | 7% by weight |
| BPO- | 0.5% by weight |
| nBM- | 0.2% by weight |
| MMA- | remainder |
| Spinning Material #4 | |
| Bromobenzene- | 3% by weight |
| BPO- | 0.5% by weight |
| nBM- | 0.2% by weight |
| MMA- | remainder |
| Spinning Material #5 | |
| Bromobenzene- | 0.0% by weight |
| BPO- | 0.5% by weight |
| nBM- | 0.2% by weight |
| MMA- | remainder |

Instead of 210° C., the extrusion temperature is 230° C. and the fiber layers are in pair-wise contact for 30 seconds. In this Example, the diffusion tube is 300 mm long and maintained at 240° C. FIG. 3 shows a representative radial index of refraction of the GI POF fabricated according to Example 2.

### EXAMPLE 3

Example 3 discloses another 5 layer GI POF in which each layer comprises a PMMA homopolymer doped with bromobenzene and a method of making the same. The same method described in Example 1 is used to produce the fiber of Example 3 except as noted below.

The spinning materials for Example 3 are as follows:

| | |
|---|---|
| Spinning Material #1 | |
| Bromobenzene- | 28% by weight |
| BPO- | 0.5% by weight |
| nBM- | 0.2% by weight |
| MMA- | remainder |
| Spinning Material #2 | |
| Bromobenzene- | 21% by weight |
| BPO- | 0.5% by weight |
| nBM- | 0.2% by weight |
| MMA- | remainder |
| Spinning Material #3 | |
| Bromobenzene- | 14% by weight |
| BPO- | 0.5% by weight |
| nBM- | 0.2% by weight |
| MMA- | remainder |
| Spinning Material #4 | |
| Bromobenzene- | 7% by weight |
| BPO- | 0.5% by weight |
| nBM- | 0.2% by weight |
| MMA- | remainder |
| Spinning Material #5 | |
| Bromobenzene- | 0.0% by weight |
| BPO- | 0.5% by weight |
| nBM- | 0.2% by weight |
| MMA- | remainder |

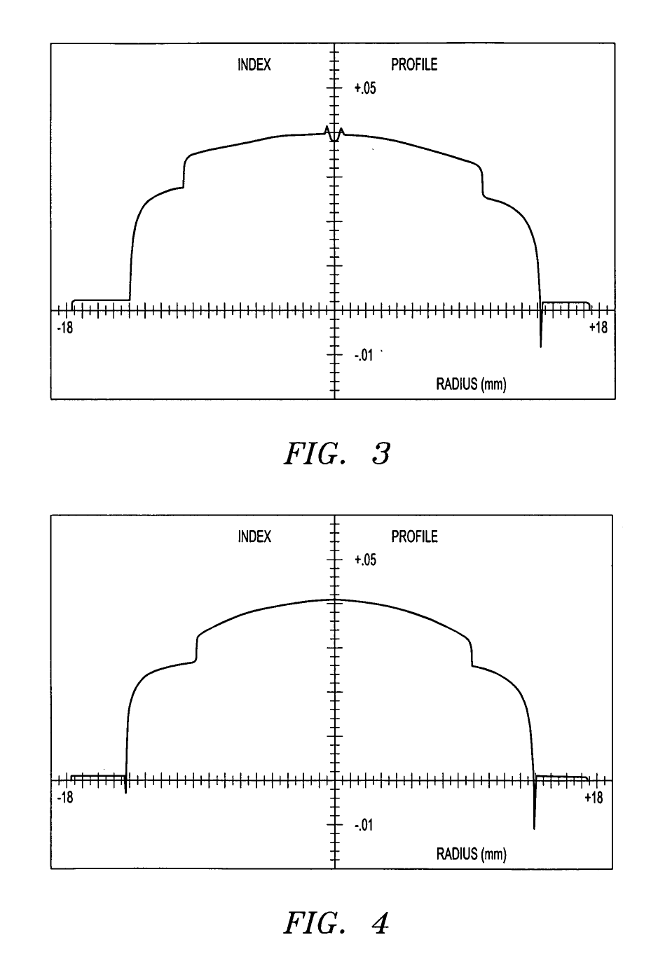

Instead of 230° C., the extrusion temperature is 190° C. and the fiber layers are in pair-wise contact for 40 seconds. In this Example, the diffusion tube is 400 mm long and maintained at 220° C. FIG. 4 shows a representative radial index of refraction of the GI POF fabricated according to Example 3.

Although the invention has been described with reference to preferred embodiments and specific examples, it will be readily appreciated by those skilled in the art that many modifications and adaptations of the invention are possible without deviating from the spirit and scope of the invention. Thus, it is to be clearly understood that this description is made only by way of example and not as a limitation on the scope of the invention as claimed below.

1. An optical fiber comprising:
at least three concentrically arranged layers wherein each said layer further comprises at least one polymer and at least one dopant;
wherein each said layer comprises less than approximately 30% by weight of said at least one dopant;
wherein said at least one dopant comprises a non-polymerizing material; and
wherein said optical fiber has a graded index of refraction.

2. The optical fiber of claim 1, wherein said at least one dopant comprises an organic molecule of less than 20 carbons, and alkyl metal oxide or a rare earth alkyl oxide.

3. The optical fiber of claim 1, wherein said at least one dopant comprises an index of refraction that varies as a function of applied electric, magnetic, and/or electromagnetic fields.

4. The optical fiber of claim 1, wherein said polymer is formed from the polymerization of monomers or prepolymers of methacrylate, stryrene and their halogenated derivatives.

5. The optical fiber of claim 1, wherein said polymer is formed from the polymerization of monomers or prepolymers selected from the group consisting of: methyl methacrylate; glycidyl methacrylate; benzyl methacrylate; phenyl methacrylate; vinyl benzoate; styrene; p-fluorostyrene; 2-chloroethyl methacrylate; isobornyl methacrylate; adamantyl methacrylate; tricylodecyl methacrylate; 1-methylcyclohexyl methacrylate; 2-chlorocyclohexyl methacrylate; glycidyl methacrylate; methyl α-chloroacrylate; 2,2,2-trifluoroethyl methacrylate; 2,2,3,3-tetrafluoropropyl methacrylate; 2,2,3,3,3-pentafluoropropyl methacrylate; 2,2,2,-trifluoro- 1-trifluoromethylethyl methacrylate; 1,3-dichloropropyl methacrylate; 2-chloro-1-chloromethylethyl methacrylate; 1-phenylethyl methacrylate; 2-phenylethyl methacrylate; diphenylmethyl methacrylate; 1,2-diphenylethyl methacrylate; 1-bromoethyl methacrylate; benzyl acrylate; α,α-dimethylbenzyl methacrylate; bornyl methacrylate; cyclohexyl methacrylate; tetrahydrofurfyl methacrylate; allyl methacrylate; tetrahydrofurfuryl methacrylate; vinyl chloroacetate; 2,2,3,4,4,4-hexafluorobutyl methacrylate; 2,2,3,3,4,4,5,5-octafluoropentyl methacrylate; 2,2,2-trifluoroethyl α-fluoroacrylate; 2,2,3,3-tetrafluoropropyl α-fluoroacrylate; 2,2,3,3,3-pentafluoropropyl α-fluoroacrylate; 2,2,3,3,4,4,5,5-octafluoropentyl α-fluoroacrylate; o- or p-difluorostyrene; vinyl acetate; tert-butyl methacrylate; isopropyl methacrylate; hexadecyl methacrylate; isobutyl methacrylate; α-trifluoromethacrylates, β-fluoroacrylates, β,β-difluoroacrylates, β-trifluorormethacrylates, β,β-bis(trifluoromethyl) acrylates and α-chloroacrylates.

6. The optical fiber of claim 5, wherein each said layer comprises less than approximately 28% by weight of said at least one dopant.

7. The optical fiber of claim 5, wherein each said layer comprises less than approximately 20% by weight of said at least one dopant.

8. The optical fiber of claim 5, wherein each said layer comprises less than approximately 17% by weight of said at least one dopant.

9. An optical fiber comprising:
at least three concentrically arranged layers wherein each said layer comprises a homopolymer and at least one dopant;
wherein each said layer comprises less than approximately 30% by weight of said at least one dopant;
wherein said at least one dopant comprises a non-polymerizing material; and
wherein said optical fiber has a graded index of refraction.

10. The optical fiber of claim 9, wherein said at least one dopant comprises an organic molecule of less than 20 carbons, and alkyl metal oxide or a rare earth alkyl oxide.

11. The optical fiber of claim 9, wherein said at least one dopant comprises an index of refraction that varies as a function of applied electric, magnetic, and/or electromagnetic fields.

12. The optical fiber of claim 9, wherein said polymer is formed from the polymerization of monomers or prepolymers of methacrylate, stryrene and their halogenated derivatives.

13. The optical fiber of claim 9, wherein said homopolymer is formed from the polymerization of monomers or prepolymers selected from the group consisting of: methyl methacrylate; glycidyl methacrylate; benzyl methacrylate; phenyl methacrylate; vinyl benzoate; styrene; p-fluorostyrene; 2-chloroethyl methacrylate; isobornyl methacrylate; adamantyl methacrylate; tricylodecyl methacrylate; 1-methylcyclohexyl methacrylate; 2-chlorocyclohexyl methacrylate; glycidyl methacrylate; methyl α-chloroacrylate; 2,2,2-trifluoroethyl methacrylate; 2,2,3,3-tetrafluoropropyl methacrylate; 2,2,3,3,3-pentafluoropropyl methacrylate; 2,2,2,-trifluoro- 1-trifluoromethylethyl methacrylate; 1,3-dichloropropyl methacrylate; 2-chloro-1-chloromethylethyl methacrylate; 1-phenylethyl methacrylate; 2-phenylethyl methacrylate; diphenylmethyl methacrylate; 1,2-diphenylethyl methacrylate; 1-bromoethyl methacrylate; benzyl acrylate; α,α-dimethylbenzyl methacrylate; bornyl methacrylate; cyclohexyl methacrylate; tetrahydrofurfyl methacrylate; allyl methacrylate; tetrahydrofurfuryl methacrylate; vinyl chloroacetate; 2,2,3,4,4,4-hexafluorobutyl methacrylate; 2,2,3,3,4,4,5,5-octafluoropentyl methacrylate; 2,2,2-trifluoroethyl α-fluoroacrylate; 2,2,3,3-tetrafluoropropyl α-fluoroacrylate; 2,2,3,3,3-pentafluoropropyl α-fluoroacrylate; 2,2,3,3,4,4,5,5-octafluoropentyl α-fluoroacrylate; o- or p-difluorostyrene; vinyl acetate; tert-butyl methacrylate; isopropyl methacrylate; hexadecyl methacrylate; isobutyl methacrylate; α-trifluoromethacrylates, β-fluoroacrylates, β,β-difluoroacrylates, β-trifluoromethacrylates, β,β-bis(trifluoromethyl) acrylates and α-chloroacrylates.

14. The optical fiber of claim 9, wherein said one or more dopants are selected from the group consisting of: diphenyl phthalate, phenyl benzoate, benzylbutylphthalate, benzyl benzoate, diphenyl sulfide, 3-phenyl-1-propanol, benzyl methacrylate, halogenated cyclic or acyclic compounds with less than 20 carbons, such as bromobenzene, 1,4 dibromobenzene, bromonapthalene, 1, 2, 4-trichloro benzene, o-dichlorobenzene, m-dichlorobenzene, 1,2-dibromethane, phthalic acids, benzoic acids, naphthalenes, cyclic ethers such as dibenzyl ether, phenoxy toluene, diphenyl ether, bicyclic compounds such as biphenyl, diphenyl sulfide, diphenyl methane 1-methoxyphenyl-1-phenylethane, alkyl metal oxides and rare earth alkyl oxides.

15. The optical fiber of claim 9, wherein each said layer comprises less than approximately 28% by weight of said at least one dopant.

16. The optical fiber of claim 9, wherein each said layer comprises less than approximately 20% by weight of said at least one dopant.

17. The optical fiber of claim 9, wherein each said layer comprises less than approximately 17% by weight of said at least one dopant.

18. The optical fiber of claim 14, further comprising a protective layer.

19. The optical fiber of claim 18, wherein said protective layer comprises a polymer selected from the group consisting of: perflouroalky-oxy polymers, amorphous flouropolymers, and flourinated ethylene propelyne copolymers.

20. An optical fiber comprising:
at least three concentrically arranged layers wherein each said layer comprises the same homopolymer and at least one dopant;
wherein each said layer comprises less than approximately 30% by weight of said at least one dopant;
wherein said at least one dopant comprises a non-polymerizing material; and
wherein said optical fiber has a graded index of refraction.

21. The optical fiber of claim 20, wherein said at least one dopant comprises an organic molecule of less than 20 carbons, and alkyl metal oxide or a rare earth alkyl oxide.

22. The optical fiber of claim 20, wherein said at least one dopant comprises an index of refraction that varies as a function of applied electric, magnetic, and/or electromagnetic fields.

23. The optical fiber of claim 21, wherein said homopolymer is formed from the polymerization of monomers or prepolymers of methacrylate, stryrene and their halogenated derivatives.

24. The optical fiber of claim 21, wherein said homopolymer is formed from the polymerization of monomers or prepolymers selected from the group consisting of: methyl methacrylate; glycidyl methacrylate; benzyl methacrylate; phenyl methacrylate; vinyl benzoate; styrene; p-fluorostyrene; 2-chloroethyl methacrylate; isobornyl methacrylate; adamantyl methacrylate; tricylodecyl methacrylate; 1-methylcyclohexyl methacrylate; 2-chlorocyclohexyl methacrylate; glycidyl methacrylate; methyl α-chloroacrylate; 2,2,2-trifluoroethyl methacrylate; 2,2,3,3-tetrafluoropropyl methacrylate; 2,2,3,3,3-pentafluoropropyl methacrylate; 2,2,2,-trifluoro-1-trifluoromethylethyl methacrylate; 1,3-dichloropropyl methacrylate; 2-chloro-1-chloromethylethyl methacrylate; 1-phenylethyl methacrylate; 2-phenylethyl methacrylate; diphenylmethyl methacrylate; 1,2-diphenylethyl methacrylate; 1-bromoethyl methacrylate; benzyl acrylate; α,α-dimethylbenzyl methacrylate; bornyl methacrylate; cyclohexyl methacrylate; tetrahydrofurfyl methacrylate; allyl methacrylate; tetrahydrofurfuryl methacrylate; vinyl chloroacetate; 2,2,3,4,4,4-hexafluorobutyl methacrylate; 2,2,3,3,4,4,5,5-octafluoropentyl methacrylate; 2,2,2-trifluoroethyl α-fluoroacrylate; 2,2,3,3-tetrafluoropropyl α-fluoroacrylate; 2,2,3,3,3-pentafluoropropyl α-fluoroacrylate; 2,2,3,3,4,4,5,5-octafluoropentyl α-fluoroacrylate; o- or p-difluorostyrene; vinyl acetate; tert-butyl metbacrylate; isopropyl methacrylate; hexadecyl methacrylate; isobutyl methacrylate; α-trifluoromethacrylates, β-fluoroacrylates, β,β-difluoroacrylates, β-trifluoromethacrylates, β,β-bis(trifluoromethyl) acrylates and α-chloroacrylates.

25. The optical fiber of claim 20, wherein said one or more dopants are selected from the group consisting of: diphenyl phthalate, phenyl benzoate, benzylbutylphthalate, benzyl benzoate, diphenyl sulfide, 3-phenyl-1-propanol, benzyl methacrylate, halogenated cyclic or acyclic compounds with less than 20 carbons, such as bromobenzene, 1,4 dibromobenzene, bromonapthalene, 1, 2, 4-trichloro benzene, o-dichlorobenzene, m-dichlorobenzene, 1,2-dibromethane, phthalic acids, benzoic acids, naphthalenes, cyclic ethers such as dibenzyl ether, phenoxy toluene, diphenyl ether, bicyclic compounds such as biphenyl, diphenyl sulfide, diphenyl methane 1-methoxyphenyl-1-phenylethane, alkyl metal oxides and rare earth alkyl oxides.

26. The optical fiber of claim 25, wherein each said layer comprises less than approximately 28% by weight of said at least one dopant.

27. The optical fiber of claim 25, wherein each said layer comprises less than approximately 20% by weight of said at least one dopant.

28. The optical fiber of claim 25, wherein each said layer comprises less than approximately 17% by weight of said at least one dopant.

29. The optical fiber of claim 25, further comprising a protective layer.

30. The optical fiber of claim 29, wherein said protective layer comprises a copolymer of approximately 65-95% by weight vinylidene flouride and approximately 5-35% by weight of tetrafluoroethylene.

31. An optical fiber comprising:
at least five concentrically arranged layers wherein each said layer comprises the same homopolymer and bromobenzene; and
wherein said optical fiber has a graded index of refraction.

32. The optical fiber of claim 31, wherein said homopolymer is formed from the polymerization of monomers or prepolymers of methacrylate, stryrene and their halogenated derivatives.

33. The optical fiber of claim 31, wherein said homopolymer is formed from the polymerization of monomers or prepolymers selected from the group consisting of: methyl methacrylate; glycidyl methacrylate; benzyl methacrylate; phenyl methacrylate; vinyl benzoate; styrene; p-fluorostyrene; 2-chloroethyl methacrylate; isobornyl methacrylate; adamantyl methacrylate; tricylodecyl methacrylate; 1-methylcyclohexyl methacrylate; 2-chlorocyclohexyl methacrylate; glycidyl methacrylate; methyl α-chloroacrylate; 2,2,2-trifluoroethyl methacrylate; 2,2,3,3-tetrafluoropropyl methacrylate; 2,2,3,3,3-pentafluoropropyl methacrylate; 2,2,2,-trifluoro-1-trifluoromethylethyl methacrylate; 1,3-dichloropropyl methacrylate; 2-chloro-1-chloromethylethyl methacrylate; 1-phenylethyl methacrylate; 2-phenylethyl methacrylate; diphenylmethyl methacrylate; 1,2-diphenylethyl methacrylate; 1-bromoethyl methacrylate; benzyl acrylate; α,α-dimethylbenzyl methacrylate; bornyl methacrylate; cyclohexyl methacrylate; tetrahydrofurfyl methacrylate; allyl methacrylate; tetrahydrofurfuryl methacrylate; vinyl chloroacetate; 2,2,3,4,4,4-hexafluorobutyl methacrylate; 2,2,3,3,4,4,5,5-octafluoropentyl methacrylate; 2,2,2-trifluoroethyl α-fluoroacrylate; 2,2,3,3-tetrafluoropropyl α-fluoroacrylate; 2,2,3,3,3-pentafluoropropyl α-fluoroacrylate; 2,2,3,3,4,4,5,5-octafluoropentyl α-fluoroacrylate; o- or p-difluorostyrene; vinyl acetate; tert-butyl methacrylate; isopropyl methacrylate; hexadecyl methacrylate; isobutyl methacrylate; α-trifluoromethacrylates, β-fluoroacrylates, β,β-difluoroacrylates, β-trifluoromethacrylates, β,β-bis(trifluoromethyl) acrylates and α-chloroacrylates.

34. The optical fiber of claim 31, wherein each said layer comprises less than approximately 30% by weight of said bromobenzene.

35. The optical fiber of claim 31, wherein each said layer comprises less than approximately 28% by weight of said bromobenzene.

36. The optical fiber of claim 31, wherein each said layer comprises less than approximately 20% by weight of said bromobenzene.

37. The optical fiber of claim 31, wherein each said layer comprises less than approximately 17% by weight of said bromobenzene.

38. The optical fiber of claim 34 further comprising a protective layer.

39. The optical fiber of claim 38, wherein said protective layer comprises a copolymer of approximately 65-95% by weight vinylidene flouride and approximately 5-35% by weight of tetrafluoroethylene.

40. An optical fiber comprising:
five concentrically arranged layers wherein the first layer has a thickness of approximately 0.25 mm, the second, third and fourth layers each have a thickness of approximately 0.075 mm and the fifth layer has a thickness of approximately 0.15 mm;
wherein each said layer comprises the same homopolymer and bromobenzene; and
wherein said optical fiber has a graded index of refraction.

41. The optical fiber of claim 40, wherein said homopolymer is formed from the polymerization of monomers or prepolymers of methacrylate, stryrene and their halogenated derivatives.

42. The optical fiber of claim 40, wherein said homopolymer is formed from the polymerization of monomers or prepolymers selected from the group consisting of: methyl methacrylate; glycidyl methacrylate; benzyl methacrylate; phenyl methacrylate; vinyl benzoate; styrene; p-fluorostyrene; 2-chloroethyl methacrylate; isobornyl methacrylate; adamantyl methacrylate; tricylodecyl methacrylate; 1-methylcyclohexyl methacrylate; 2-chlorocyclohexyl methacrylate; glycidyl methacrylate; methyl α-chloroacrylate; 2,2,2-trifluoroethyl methacrylate; 2,2,3,3-tetrafluoropropyl methacrylate; 2,2,3,3,3-pentafluoropropyl methacrylate; 2,2,2,-trifluoro-1-trifluoromethylethyl methacrylate; 1,3-dichloropropyl methacrylate; 2-chloro-1-chloromethylethyl methacrylate; 1-phenylethyl methacrylate; 2-phenylethyl methacrylate; diphenylmethyl methacrylate; 1,2-diphenylethyl methacrylate; 1-bromoethyl methacrylate; benzyl acrylate; α,α-dimethylbenzyl methacrylate; bornyl methacrylate; cyclohexyl methacrylate; tetrahydrofurfyl methacrylate; allyl methacrylate; tetrahydrofurfuryl methacrylate; vinyl chloroacetate; 2,2,3,4,4,4-hexafluorobutyl methacrylate; 2,2,3,3,4,4,5,5-octafluoropentyl methacrylate; 2,2,2-trifluoroethyl α-fluoroacrylate; 2,2,3,3-tetrafluoropropyl α-fluoroacrylate; 2,2,3,3,3-pentafluoropropyl α-fluoroacrylate; 2,2,3,3,4,4,5,5-octafluoropentyl α-fluoroacrylate; o- or p-difluorostyrene; vinyl acetate; tert-butyl methacrylate; isopropyl methacrylate; hexadecyl methacrylate; isobutyl methacrylate; α-trifluoromethacrylates, β-fluoroacrylates, β,β-difluoroacrylates, β-trifluoromethacrylates, β,β-bis(trifluoromethyl) acrylates and α-chloroacrylates.

43. The optical fiber of claim 40, wherein each said layer comprises less than approximately 30% by weight of said bromobenzene.

44. The optical fiber of claim 40, wherein each said layer comprises less than approximately 28% by weight of said bromobenzene.

45. The optical fiber of claim 40, wherein each said layer comprises less than approximately 20% by weight of said bromobenzene.

46. The optical fiber of claim 40, wherein each said layer comprises less than approximately 17% by weight of said bromobenzene.

47. The optical fiber of claim 40, further comprising a protective layer.

48. The optical fiber of claim 47 wherein said protective layer comprises a copolymer of approximately 65-95% by weight vinylidene flouride and approximately 5-35% by weight of tetrafluoroethylene.

49. An optical fiber comprising:
five concentrically arranged layers wherein each layer comprises a PMMA homopolymer and bromobenzene; and
wherein said optical fiber has a graded index of refraction.

50. The optical fiber of claim 49, wherein each said layer comprises less than approximately 30% by weight of said bromobenzene.

51. The optical fiber of claim 49, wherein each said layer comprises less than approximately 28% by weight of said bromobenzene.

52. The optical fiber of claim 49, wherein each said layer comprises less than approximately 20% by weight of said bromobenzene.

53. The optical fiber of claim 49, wherein each said layer comprises less than approximately 17% by weight of said bromobenzene.

54. The optical fiber of Example 1.

55. The optical fiber of Example 2.

56. The optical fiber of Example 3.
